(19) United States
(12) Patent Application Publication
(10) Pub. No.: US 2005/0050743 A1
(43) Pub. Date: Mar. 10, 2005

(54) Blade replaceable saw with angularly adjustable handle

(75) Inventor: Tokuichi Kabasawa, Santo-gun (JP)

Correspondence Address: Gerald Levy;Pitney, Hardin, Kipp & Szuch LLP, 685 Third Avenue, New York, NY, 10017, US

(73) Assignee: Kabasawa Industry Co., Ltd.

(21) Appl. No.: 10/658,304

(22) Filed: Sep. 9, 2003

(51) Int. Cl. B23D 51/01

(52) U.S. Cl. 30/517

(57) ABSTRACT

A replaceable saw comprises a saw blade having saw teeth and an insertion portion, a notch being formed in the insertion portion so as to extend in a direction in which the saw blade is inserted, a support member which supports the insertion portion of the saw blade via a blade replacing mechanism and which includes a pair of installation pieces defining an insertion gap into which the insertion portion can be inserted, a through hole formed in one of the installation pieces, an attaching nut formed in the other installation piece, and an attaching bolt inserted through the through hole and the notch and which can be screwed into the attaching nut, and a handle connected to the support member via a rotational position adjusting mechanism comprising a pair of branching portions formed in the handle so as to sandwich the support member between them, a through hole formed in one of the branching portions, a nut mounted in the other branching portion, a supporting hole formed in the support member, and a pivoting bolt inserted through the through hole and the supporting hole and which can be screwed into the nut.

### BACKGROUND OF THE INVENTION

1. Field of the Invention

The present invention relates to a replaceable saw that allows the replacement of, for example, a saw blade that becomes dull, and more specifically, to a replaceable saw that allows the adjustment of the angle between a saw blade and a saw handle.

2. Description of the Related Art

A known replaceable saw of this kind is designed so that a saw blade having saw teeth is installed on a saw handle so that the saw blade can be replaced using a blade replacing mechanism.

However, in this conventional structure, the position of the saw blade relative to the saw handle is fixed. Thus, this structure cannot deal with various sawing operation positions corresponding to a downward, obliquely upward, horizontal, and other sawing operations. It therefore has disadvantage of lacking flexibility and comfortableness in use.

### SUMMARY OF THE INVENTION

It is an object of the present invention to solve these problems.

To accomplish this object, a replaceable saw according to an aspect of the present invention is characterized by comprising a saw blade having saw teeth and an insertion portion, a support member that supports the insertion portion of the saw blade via a blade replacing mechanism, and a handle connected to the support member via a rotational position adjusting mechanism.

In this case, the rotational position adjusting mechanism may include a pair of branching portions formed in the handle so as to sandwich the support member between them, a through hole formed in one of the branching portions, a nut mounted in the other branching portion, a supporting hole formed in the support member, and a pivoting bolt inserted through the through hole and the supporting hole and which can be screwed into the nut.

Furthermore, it is preferable to have a surface detent mechanism provided between a surface of the one of the branching portions and an opposite surface of the support member and composed of detent teeth surfaces that can be engaged with and disengaged from each other.

Moreover, the blade replacing mechanism may include a notch formed in the insertion portion so as to extend in a direction in which the saw blade is inserted, a pair of installation pieces formed in the support member and defining an insertion gap into which the insertion portion can be inserted, a through hole formed in one of the installation pieces, an attaching nut mounted in the other installation piece, and an attaching bolt inserted through the through hole and the notch and which can be screwed into the attaching nut.

In this case, the insertion portion preferably has a positioning hole formed in a bottom end portion of the notch. The attaching bolt preferably has a positioning tapered portion that can be pressed into contact with the positioning hole portion.

To accomplish the object above, a replaceable saw according to another aspect of the present invention is characterized by comprising a saw blade having saw teeth and an insertion portion, a notch being formed in the insertion portion so as to extend in a direction in which the saw blade is inserted,
a support member which supports the insertion portion of the saw blade via a blade replacing mechanism and which includes a pair of installation pieces defining an insertion gap into which the insertion portion can be inserted, a through hole formed in one of the installation pieces, an attaching nut mounted in the other installation piece, and an attaching bolt inserted through the through hole and the notch and which can be screwed into the attaching nut, and
a handle connected to the support member via a rotational position adjusting mechanism comprising a pair of branching portions formed in the handle so as to sandwich the support member between them, a through hole formed in one of the branching portions, a nut mounted in the other branching portion, a supporting hole formed in the support member, and a pivoting bolt inserted through the through hole and the supporting hole and which can be screwed into the nut.

The attaching bolt preferably has a head portion having a knurled surface and a diameter larger than the width of each of the branching portions.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a side view showing an embodiment of the present invention;

FIG. 2 is an exploded perspective view showing the embodiment of the present invention;

FIG. 3 is a side view of a part of the embodiment of the present invention; and

FIG. 4 is a sectional view taken along line IV-IV in FIG. 1; and

FIG. 5 is a sectional view taken along line V-V in FIG. 1.

### DETAILED DESCRIPTION OF PREFERRED EMBODIMENT

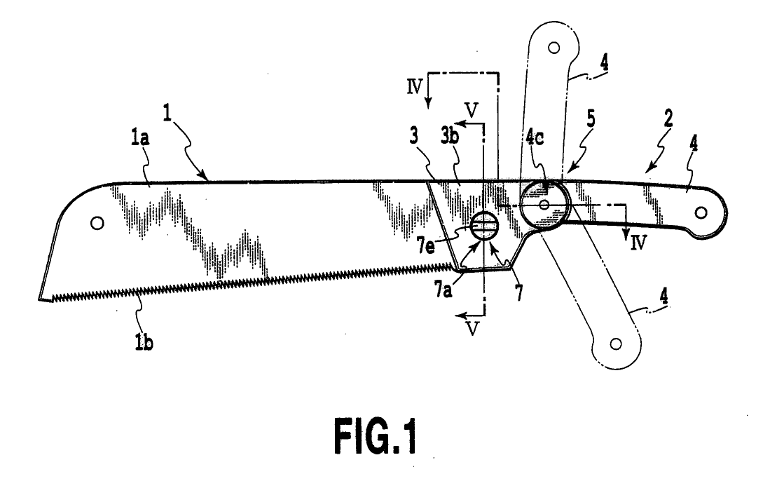

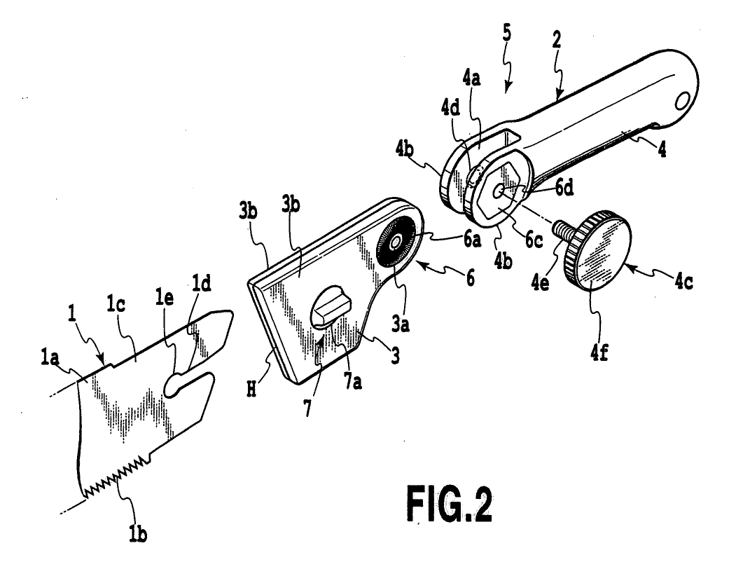

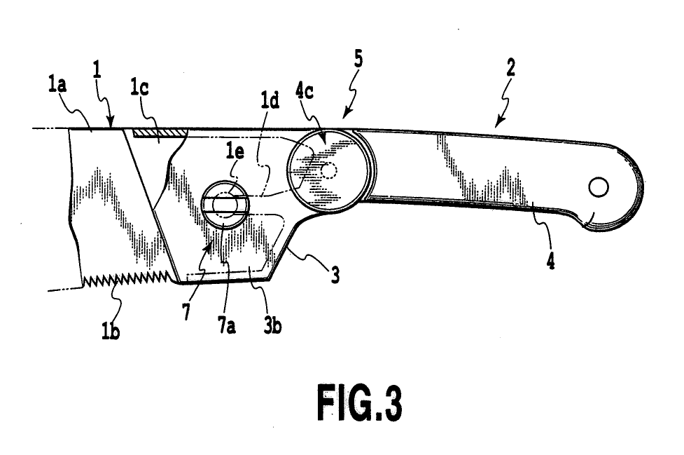

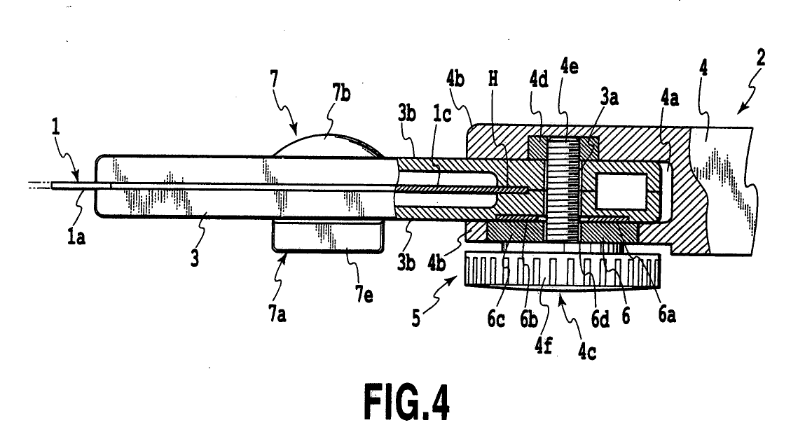

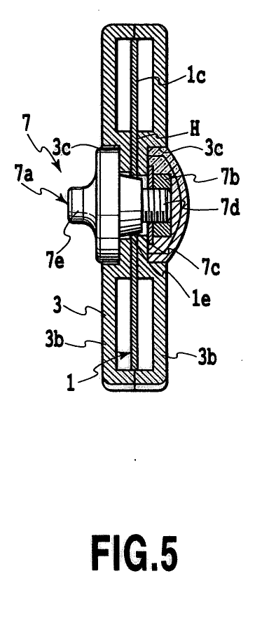

FIGS. 1 to 5 show an embodiment of the present invention. Reference numeral 1 denotes a saw blade which is made of metal and which has a saw body 1a having a plurality of saw teeth 1b formed at its edge. The blade 1 has an insertion portion 1c in its proximal portion in which a notch 1d is formed, the notch 1d extending in the direction in which the saw blade 1 is inserted. A positioning hole le is formed in the bottom end portion of the notch 1d and has a diameter larger than the width of the notch 1d (see FIG. 2).

Reference numeral 2 denotes a saw handle made of wood or synthetic resin and formed of a support member 3 that supports the saw blade 1 and a handle 4 gripped by an operator. A rotational position adjusting mechanism 5 is provided which can adjust the rotational position of the handle 4 relative to the support member 3.

In the present embodiment, the rotational position adjusting mechanism 5 is configured as described below. Specifically, the handle 4 has a fitting insertion ditch portion 4a formed at its tip portion into which the proximal portion of the support member 3 can be fittingly inserted, and a pair of branching portions 4b, 4b between which the support member 3 can be sandwiched. The pair of branching portions 4b, 4b is bifurcated so that the branching portions 4b, 4b lie opposite to each other. A hexagonal detent piece 6c is embedded in one of the branching portions 4b. The detent piece 6c constitutes a part of a detent mechanism 6, described later, and has a through hole 6d formed in its center. A nut 4d is embedded in the other branching portion 4b so that a pivoting bolt 4c can be screwed into the nut 4d. Furthermore, a supporting hole 3a is formed in the support member 3 so that the pivoting bolt 4c can be inserted through the supporting hole 3a. The pivoting bolt 4c is inserted through the through hole 6d in the detent piece 6c and the supporting hole 3a in the support member 3 and is then screwed into the nut 4d. A surface detent mechanism 6 is provided between each surface of the one of the branching portions 4b and the opposite surface of the support member 3. The pivoting bolt 4c has a threaded portion 4e inserted through the through hole 6d and the supporting hole 3a and screwed into the nut 4d, and a head portion 4f having a diameter larger than the width of the branching portion 4b. The head portion 4f is knurled in order to facilitate a rotative moving operation.

The surface detent mechanism 6 includes a radial detent teeth surface 6a formed around the supporting hole 3a in a surface of the support member 3 which is opposite to the one of the branching portions 4b and a detent teeth surface 6b formed radially in the detent piece 6c around the through hole 6d, i.e. the axis of the pivoting bolt 4c. The surface detent mechanism 6 enables the detent teeth surface 6a to be engaged with and disengaged from the detent teeth surface 6b by changing the degree of screwing of the pivoting bolt 4c into the nut 4d.

Thus, to adjust the saw blade 1 and the handle 4 to angles in accordance with a sawing operation position, the pivoting bolt 4c may be rotatively moved and loosened. Then, the handle 4 may be rotatively moved through a predetermined angle around the axis of the pivoting bolt 4c relative to the support member 3. Then, at this angular position, the pivoting bolt 4c may be rotatively moved and tightened. As a result, the support member 3 supporting the saw blade 1 is sandwiched between the branching portions 4b and 4b. The handle 4 is fixed to the support member 3 at a predetermined angular position.

Now, a blade replacing mechanism 7 will be described. In the present embodiment, the support member 3 is provided with a pair of installation pieces 3b, 3b which defines an insertion gap H into which the insertion portion 1c can be inserted so as to be sandwiched between the installation pieces 3b and 3b. The installation pieces 3b, 3b are arranged opposite each other. The installation pieces 3b, 3b are formed with stepped holes 3c, 3c, respectively. An attaching nut 7b is embedded in the stepped hole 3c in one of the installation pieces 3b. An attaching bolt 7a inserted into the stepped hole 3c in the other installation piece 3b can be screwed into the attaching nut 7b in the one of the installation pieces 3b. The attaching bolt 7a according to the present embodiment has a threaded portion 7d which has a diameter smaller than the width of the notch 1d and which is screwed into the attaching nut 7b, a tapered portion 7c that can be pressed into contact with the inner peripheral surface of the positioning hole le in the saw blade 1, and a tab portion 7e.

The attaching bolt 7a is rotatively moved and loosened so that its threaded portion 7d is located in the notch 1d. Then, the insertion portion 1c of the saw blade 1 can be pulled out of the insertion gap H. On the other hand, the old saw blade 1 is pulled out, the insertion portion 1c of a new saw blade 1 is then inserted into the insertion gap H, and the attaching bolt 7a is subsequently rotatively moved and tightened. Then, the insertion portion 1c of the new saw blade 1 is sandwiched and held between the installation pieces 3b and 3b. At the same time, the positioning tapered portion 7c of the attaching bolt 7a is pressed into the positioning hole 1e. Consequently, the saw blade 1 is reliably and tightly supported in the support member 3. This allows the saw blade 1 to be easily removed from the support member 3 and replaced with a new one.

This embodiment is configured as described above. Accordingly, the rotational position adjusting mechanism 5 can be used to adjust the rotational position of the handle 4 with respect to the support member 3. Therefore, it is possible to improve flexibility and comfortableness in use by adjusting the rotational position of the handle 4 with respect to the support member 3 in accordance with a sawing operation position corresponding to a downward, obliquely upward, horizontal, or other sawing operation.

The present invention is not limited to the above embodiment. It is possible to design and change appropriately the structures, forms, and the like of the saw blade 1, handle body 2, support member 3, handle 4, and rotational position adjusting mechanism 5. Moreover, the present invention can be used for both double-edged saws and single-edged saws.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirits of the invention.

1. A replaceable saw comprising:
a saw blade having saw teeth and an insertion portion;
a support member that supports the insertion portion of the saw blade via a blade replacing mechanism; and
a handle connected to the support member via a rotational position adjusting mechanism.

2. A replaceable saw according to claim 1, wherein said rotational position adjusting mechanism includes:
a pair of branching portions formed in said handle so as to sandwich said support member between them,
a through hole formed in one of the branching portions,
a nut mounted in the other branching portion;
a supporting hole formed in said support member; and
a pivoting bolt inserted through said through hole and said supporting hole and which can be screwed into said nut.

3. A replaceable saw according to claim 2, further comprising:
a surface detent mechanism provided between a surface of said one of the branching portions and an opposite surface of said support member and composed of detent teeth surfaces that can be engaged with and disengaged from each other.

4. A replaceable saw according to claim 1, wherein said blade replacing mechanism includes:
a notch formed in said insertion portion so as to extend in a direction in which the saw blade is inserted;
a pair of installation pieces formed in the support member and defining an insertion gap into which said insertion portion can be inserted,
a through hole formed in one of the installation pieces,
an attaching nut mounted in the other installation piece; and
an attaching bolt inserted through said through hole and said notch and which can be screwed into said attaching nut.

5. A replaceable saw according to claim 4, wherein said insertion portion has a positioning hole portion formed in a bottom end portion of said notch, and said attaching bolt has a positioning tapered portion that can be pressed into contact with the positioning hole portion.

6. A replaceable saw comprising:
a saw blade having saw teeth and an insertion portion, a notch being formed in said insertion portion so as to extend in a direction in which the saw blade is inserted;
a support member which supports the insertion portion of the saw blade via a blade replacing mechanism and which includes a pair of installation pieces defining an insertion gap into which said insertion portion can be inserted, a through hole formed in one of the installation pieces, an attaching nut mounted in the other installation piece, and an attaching bolt inserted through said through hole and said notch and which can be screwed into said attaching nut; and
a handle connected to the support member via a rotational position adjusting mechanism comprising a pair of branching portions formed in the handle so as to sandwich said support member between them, a through hole formed in one of the branching portions, a nut mounted in the other branching portion, a supporting hole formed in said support member, and a pivoting bolt inserted through said through hole and said supporting hole and which can be screwed into said nut.

7. A replaceable saw according to claim 6, further comprising: a surface detent mechanism provided between a surface of said one of the branching portions and an opposite surface of said support member and composed of detent teeth surfaces that can be engaged with and disengaged from each other.

8. A replaceable saw according to claim 7, wherein said insertion portion has a positioning hole formed in a bottom end portion of said notch, and said attaching bolt has a positioning tapered portion that can be pressed into contact with the positioning hole.

9. A replaceable saw according to claim 8, wherein said attaching bolt has a head portion having a knurled surface and a diameter larger than the width of each of said branching portions.
